(19) United States
(12) Patent Application Publication
(10) Pub. No.: US 2004/0030651 A1
(43) Pub. Date: Feb. 12, 2004

(54) Method and apparatus for distributing content through on-line network

(76) Inventors: Jin-Sung Kim, Seoul (KR); Kyung-Keun Byun, Seoul (KR); Jong-In Seok, Seoul (KR)

Correspondence Address: CANTOR COLBURN, LLP, 55 GRIFFIN ROAD SOUTH, BLOOMFIELD, CT, 06002

(21) Appl. No.: 10/336,110

(22) Filed: Jan. 3, 2003

(30) Foreign Application Priority Data
Aug. 8, 2002 (KR) 2002-46788

(51) Int. Cl. G06F 17/60

(52) U.S. Cl. 705/51

(57) ABSTRACT

Disclosed are a method and an apparatus for distributing digital content from a service provider to a user through an on-line system of a computer communication network. The service provider prepares the digital content. A first user downloads the digital content. A second user downloads the digital content from the first user. The second user requests permission to the service provider for using the digital content. The service provider authenticates a use of the digital content. The second user uses the digital content when an authentication for the use of the downloaded digital content is achieved. The service provider distributes a profit to the first user, who relays the authenticated digital content. It is possible to provide a P2P infra for allowing users to distribute the digital content.

### BACKGROUND OF THE INVENTION

1. Field of the Invention

The present invention relates to a method and an apparatus for distributing digital content through an on-line network, and more particularly to a method and an apparatus providing a Peer-to-Peer (P2P) infra to allow users to legally distribute the digital content through the on-line network.

2. Description of the Related Art

Recently, as computer communication networks, such as an Internet, are widely provided, various digital content including movie, music, game, publication and information are easily distributed between users through the Internet. Accordingly, an infringement of copyright in the on-line network is raised as a social problem.

As illegally copied works are rapidly propagated through the Internet in large quantities, a copyright holder suffers great economic loss, so it is urgent to provide a copyright management system in the on-line network.

The digital content have been distributed through the on-line network with several manners from an early stage of the Internet. According to an initial model for distributing the digital content, as shown in FIG. 1, a plurality of users access to the digital content in one service site. In this case, a traffic concentration occurs in the service site, so quality of the digital content is lowered. As a result, a great amount of cost is required to improve the quality of the digital content.

A transition-type distributing model, as shown in FIG. 2, has been suggested in order to solve the problem of the initial distributing model. According to the transition-type distributing model, several service sites are copied from the original service site by using a Content Delivery Network (CDN), thereby improving the quality of the digital content.

However, as shown in FIG. 2, since the same service sites are copied from the original service site, redundant investment is caused, so that a great amount of cost is still necessary.

Recently, as shown in FIG. 3, a future-type distributing model is provided. The future-type distributing model solves the problems of the quality lowering of the digital content of the initial distributing model and the cost increasing of the transition-type distributing model. The future-type distributing model distributes the digital content between users by using the P2P. According to the future-type distributing model, the traffic for distributing the digital content occurs between the users, so the traffic is naturally distributed, thereby preventing the quality of the digital content from being lowered caused by the traffic concentration. In addition, since the digital content are distributed through a user's computer resource and a network resource, it is not required for a service provider to make a great investment, even if an amount of the digital content to be distributed is increased.

However, recently the future-type distributing models do not suggest a solution for protecting the copyright of the digital content. Accordingly, a fee-charging service for the digital content is confronted with a difficulty, and, in an extreme case, the digital content are illegally distributed.

### SUMMARY OF THE INVENTION

The present invention has been made to solve the above problems of the prior arts. Therefore, the present invention provides a method and an apparatus for distributing the digital content through the on-line network by using a P2P and a Digital Rights Management (DRM) together with an incentive marketing technique.

The method for distributing content through the on-line network adopts the P2P having a superior digital content distributing system, the DRM capable of protecting a copyright of the digital content, and the incentive marketing technique capable of promoting the use of a distribution channel. The incentive marketing technique means that the profit is distributed according to the use of user resources. That is, sheer users are changed into distributed providers, in such a manner that the user finally becomes an individual businessman. The above business model can solve the difficulty for billing the digital content and promote the distribution of the digital content.

The present invention provides a method for distributing the digital content from a service provider to a user through an on-line system of a computer communication network, the method comprising preparing the digital content by the service provider, downloading the digital content by a first user, downloading the digital content from the first user by a second user, requesting a permission to the service provider by the second user for permitting the second user to use the digital content, authenticating a use of the digital content by the service provider, using the digital content by the second user when an authentication for the use of the digital content is achieved, and distributing a profit to the first user, who relays the digital content, by the service provider.

According to an exemplary embodiment of the present invention, the first user downloads the digital content not only from the service provider, but also from other first users, who have already downloaded the digital content.

The second user searches the digital content by accessing to the service provider, selects one of first users who already download the digital content searched by the second user, and downloads the digital content from the selected first user.

The second user selects the first user having a fastest transmission speed of the digital content with respect to the second user. In addition, the second user may select the first user depending on a preference of other second users.

The digital content are provided from a content provider, and the profit is distributed to the content provider when the users use the digital content.

The digital content provided by the content provider is processed as digital content including a DRM capable of protecting a copyright and defining a rating of the digital content.

The service provider receives information of a final relay user when the second user requests the use of the digital content, and provides a decoding key for permitting the second user to use the digital content. When the second user requests the use of the digital content, the service provider checks whether or not the digital content are reused by the second user, and permits the second user to use the digital content without the authentication if the second user reuses the digital content.

The present invention also provides an apparatus for distributing digital content from a service provider to a user through an on-line system of a computer communication network, the apparatus comprising a storage means including a digital content search database and a digital content rights management database, and a processor for operating a content distributing program through the on-line system, preparing the digital content, downloading the digital content upon receiving a request from a first user, authenticating a use of the digital content by checking the use of the digital content upon receiving a request from a second user, and distributing a profit to the first user participated in relaying the digital content to the second user.

According to an exemplary embodiment of the present invention, the digital content database includes a content ID, content meta information, and a content holding user list, and the digital content rights management database includes a content ID, accounting manner information, and an encoding key.

According to another aspect of the present invention, there is provided a method for distributing digital content from a service provider to a user through an on-line system of a computer communication network, the method comprising preparing the digital content by the service provider, downloading the digital content through a first user, requesting the digital content to the first user by the second user, informing the service provider of a distribution of the digital content to the second user by the first user, authenticating a use of the digital content for the second user by the service provider, permitting the first user to distribute the digital content to the second user by the service provider, distributing the digital content to the second user by the first user, informing the service provider of an amount of the digital content distributed to the second user from the first user by the second user, checking the amount of the digital content distributed to the second user from the first user by the service provider, and distributing a profit to the first user by the service provider according to the amount of the digital content distributed to the second user.

According to another aspect of the present invention, there is provided an apparatus for distributing digital content from a service provider to a user through an online system of a computer communication network, the apparatus comprising a storage means including a digital content search database and a digital content rights management database, and a processor for operating a content distributing program through the on-line system, preparing the digital content, downloading the digital content upon receiving a request from a first user, receiving a report from the first user informing a distribution of the digital content requested by the second user, authenticating a use of the digital content, permitting the first user to distribute the digital content to the second user, receiving a report from the second user informing an amount of the digital content thereof, checking an amount of the digital content of the first user distributed to the second user, and distributing a profit to the first user according to the amount of the digital content distributed to the second user.

### BRIEF DESCRIPTION OF THE DRAWINGS

The above object and other advantages of the present invention will become more apparent by describing in detail embodiments thereof with reference to the attached drawings in which:

FIG. 1 is a view showing an initial model for distributing content through an on-line network;

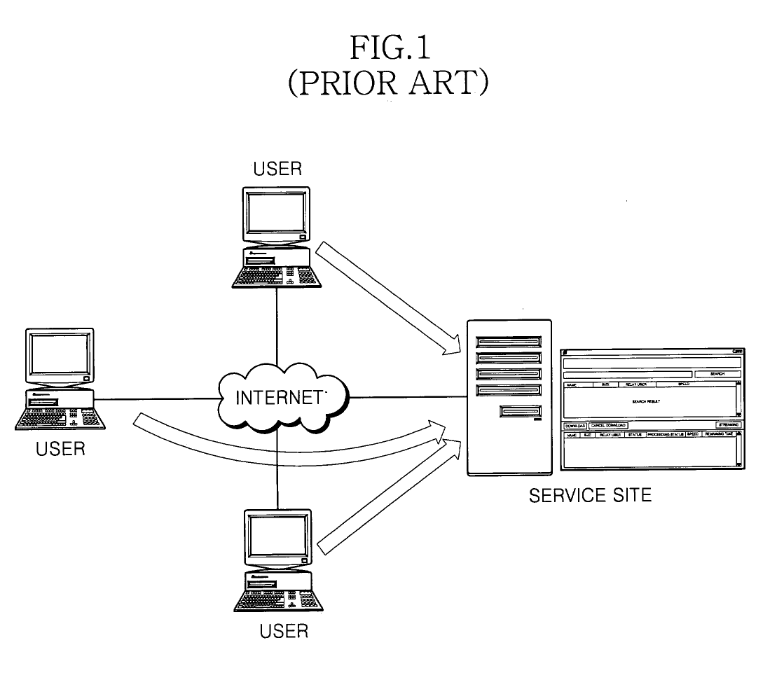

FIG. 2 is a view showing a conventional transition-type distributing model for distributing content through an on-line network;

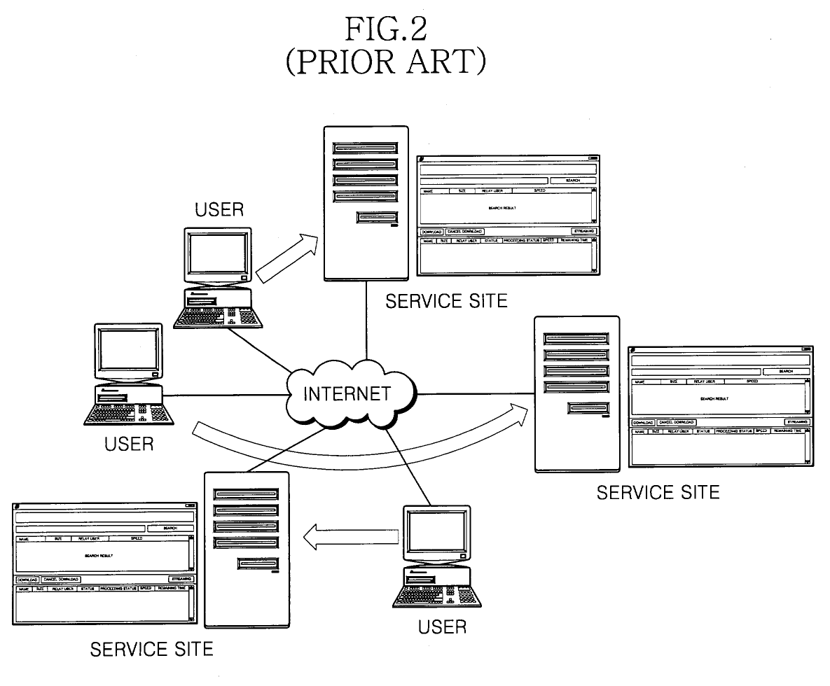

FIG. 3 is a view showing an on-line content distributing model according to one embodiment of the present invention;

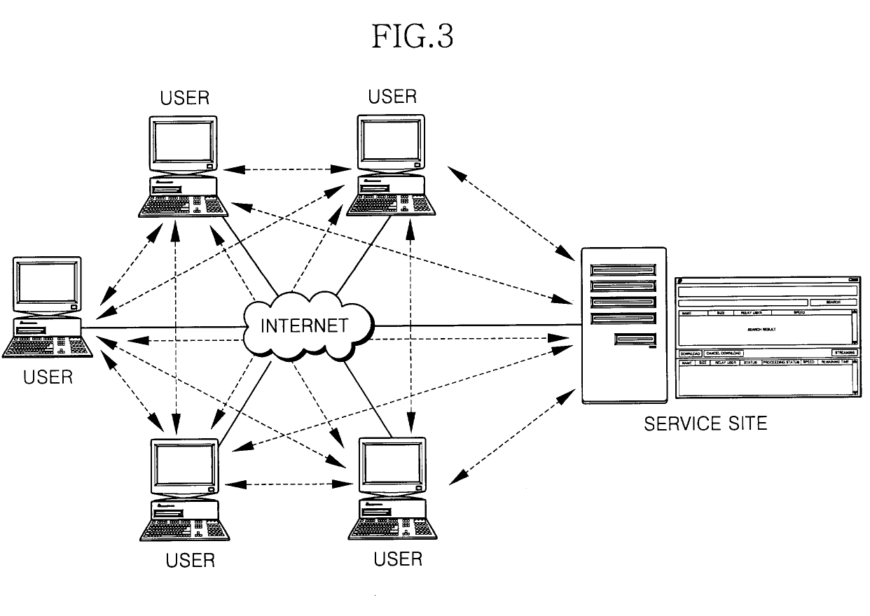

FIG. 4 is a view showing a concept of the on-line content distributing model according to one embodiment of the present invention;

FIG. 5 is a view showing a structure of an on-line content distributing model according to one embodiment of the present invention;

FIG. 6 is a view showing a structure of digital content provided with a DRM according to one embodiment of the present invention;

FIG. 7 is a view showing a structure of an on-line content distributing system and a database according to one embodiment of the present invention;

FIGS. 8 to 10 are view showing an internal structure of each database;

FIG. 11 is a view showing a download type distributing method according to one embodiment of the present invention;

FIG. 12 is view showing an internal structure of each database; and

FIG. 13 is a view showing a streaming type distributing method according to one embodiment of the present invention.

### DETAILED DESCRIPTION OF THE INVENTION

Hereinafter, exemplary embodiments of the present invention will be described in detail with reference to accompanying drawings.

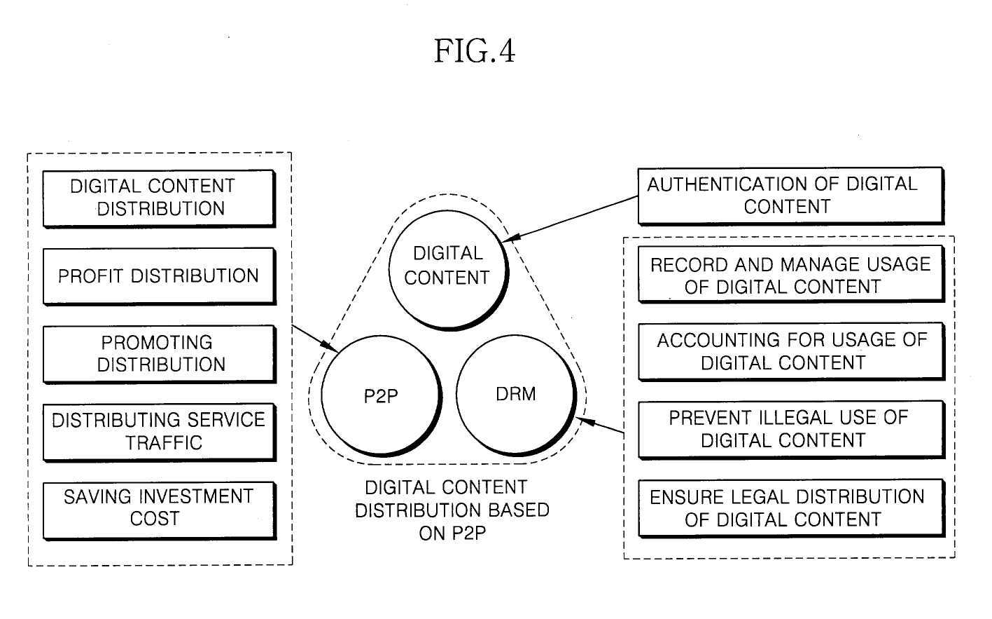

Referring to FIG. 4, the present invention forms digital content distribution channel through the digital content, a P2P, and a DRM, so as to obtain a profit.

Three components of the digital content distribution channel shown in FIG. 4 have advantages, respectively.

Firstly, the P2P allows the digital content to be distributed through a user's computer and a network, so a service provider can save an investment cost, even if an amount of the digital content to be distributed is increased. Accordingly, the profit obtained from the above business model can be distributed to users of the digital content, so it is possible for the users to reduce expenses, thereby promoting the distribution of digital content. That is, the users utilizing the digital content act as second and third digital content providers. Therefore, since a plurality of service providers always make an access to an Internet, the digital content and traffic can be distributed, so the users can easily download the digital content.

Accordingly, the digital content can be sequentially downloaded from a first user to an Nₜₕ user, and the Nₜₕ user can be a final relay user. In this case, the profit can be distributed only to the final relay user, or can be evenly or differentially distributed to all relay users.

Due to the above-mentioned profit distribution, a competition among plurality of relay users is induced, so a distribution network can be rapidly increased, thereby solving the traffic problem and promoting the use of the digital content.

Secondarily, the DRM protects the copyright, which is necessary for distributing the digital content based on the P2P. Applying the DRM to the digital content means that copyright information is included in the digital content by encoding copyright information, in such a manner that users, who have paid a charge for the, digital content, only can use the digital content. Therefore, a legal digital content distribution is ensured with preventing the digital content from being illegally used. In addition, it is possible to impose an account according to the use of the digital content while managing and recording the usage details, such that the usage details can be efficiently used as marketing data in the future.

Finally, the distributing model of the above business model can make not only a company but also a private person a content provider (CP). That is, the digital content provided by the private person can be easily distributed with a charge. In this case, it is required authenticate center, which decides whether or not the digital content provided by the private person are creative works and also decides a rating of the digital content.

The present invention ensures an on-line distribution business and an authentication business with respect to various digital content including videos (movie, animation, broadcasting, etc.), music (record, etc.), games (PC game, etc.), publications (E-book, etc) and information (education, economy, etc.).

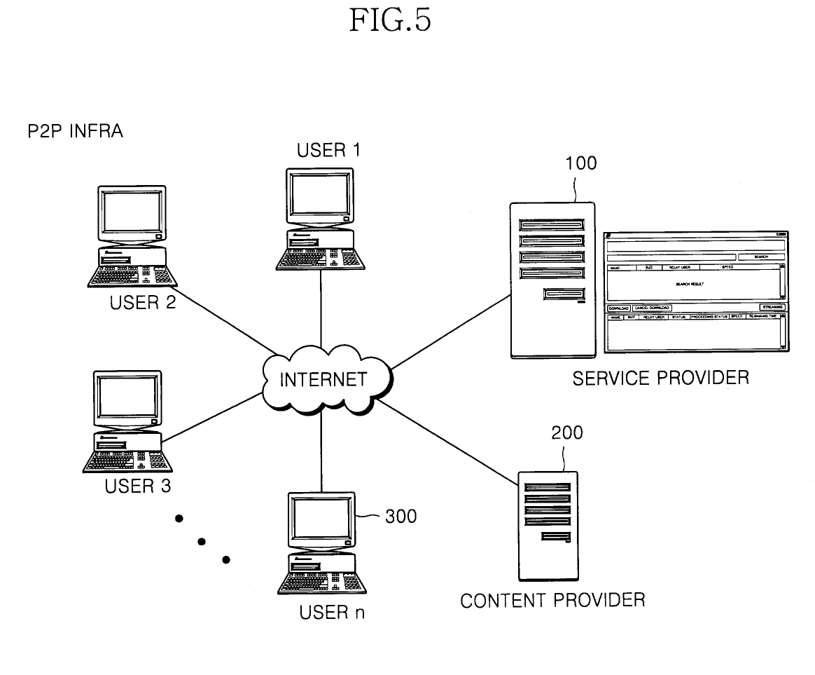

Referring to FIG. 5, a service provider 100 provides the P2P infra in order to allow users to distribute the digital content and the DRM so as to prevent the digital content from being illegally used. In addition, the service provider 100 imposes the account according to the usage of the distributed digital content, while authenticating the digital content provided by the private person.

A content provider 200 creates the digital content and provides the digital content to the service provider 100.

A user 300 uses the digital content and acts as a distributed provider by relaying the digital content to other users. In the latter case, the user 300 can share the profit as a digital content provider. In the present invention, a user relaying the digital content is called “first user” and a user using the digital content is called “second user”.

According to the present invention, the service provider, the content provider and the users are interconnected to each other through wire/wireless computer communication networks, such as the Internet, and a wireless communication network. In addition, the user downloads or transmits the digital content by accessing to the service provider or other users through a personal communication terminal including a personal computer, a notebook computer, and a PDA, or through a cellular phone capable of providing a wireless Internet service.

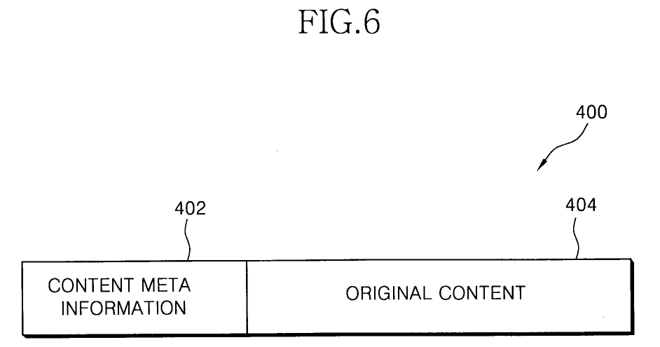

Referring to FIG. 6, the digital content 400 including the DRM comprises content meta information 402 and original content 404.

The content meta information 402 includes a content ID for identifying the content, content introduction information, copyright information, and accounting information. The content meta information 402 is encoded into a private key of a server through an asymmetric key encoding algorithm, and a client can open the content meta information 402 by using a public key of the server.

The original content 404 are encoded through a symmetric key encoding algorithm. An encoding key is prepared corresponding to each of content and the server manages the encoding key. When a client wants to use the content, a key capable of decoding the original content is downloaded through a predetermined settlement procedure.

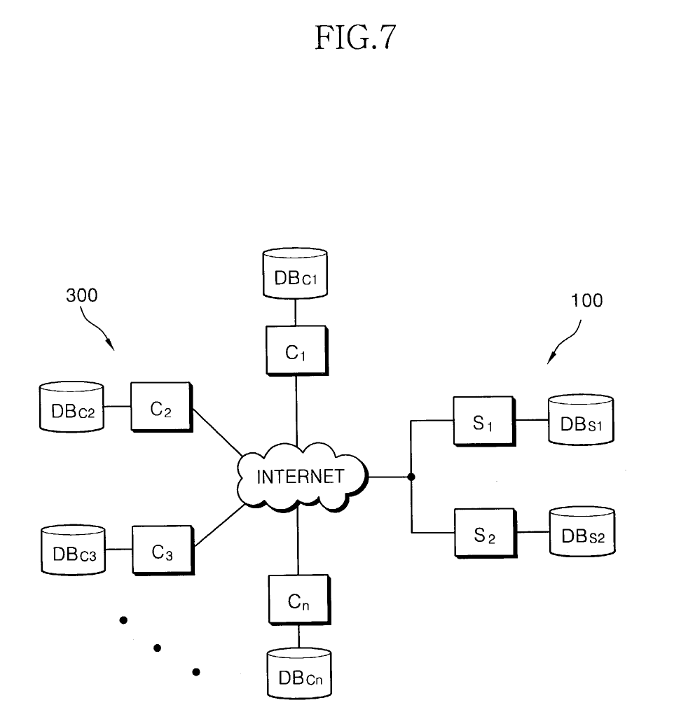

Referring to FIG. 7, a service provider 100 is a processor including a search server S1 and a management server S2. The search server S1 and the management server S2 have a digital content database DBS1 and a digital content rights management database DBS2 as storage devices. Besides, the service provider includes a plurality of servers (not shown) for providing the P2P infra and for advertising the content. Each of clients identical to the user 300 has a database DBcn. The database DBcn includes content information held by the private person for the purpose of using or relaying the digital content.

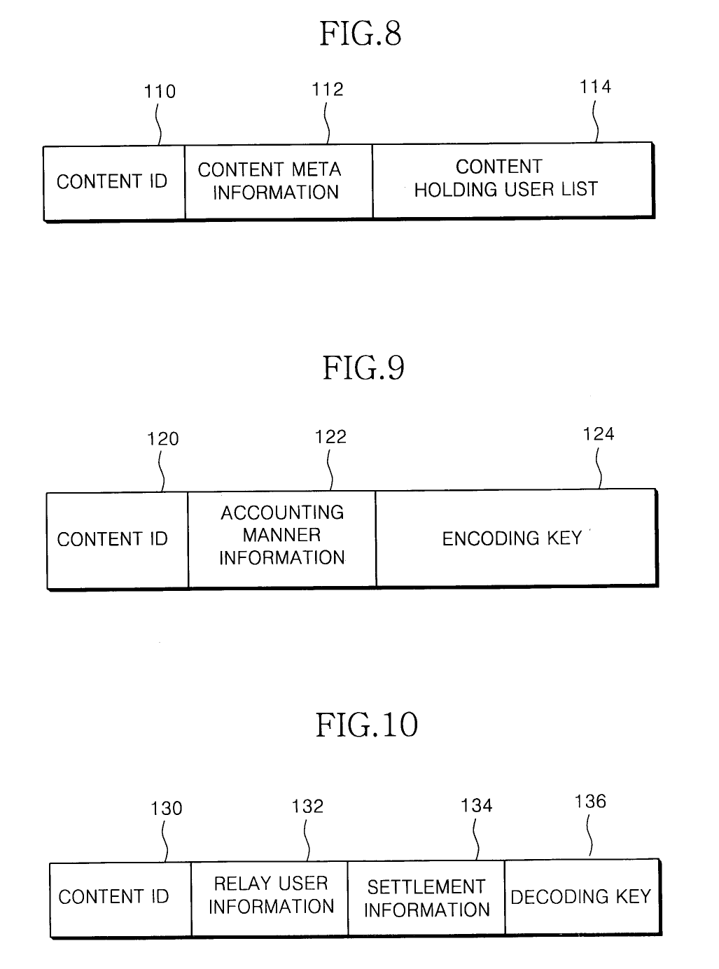

Referring to FIG. 8, in the digital content database DBS1, a content ID 110 is a unique value capable of identifying the content. In addition, the content meta information 112 is introduction information for the content, such as a content name, a class code, and a file type. In addition, a content holding user list 114 means information of clients holding the content for the purpose of the use or relay.

Referring to FIG. 9, in the digital content rights management database DBS2, content ID 120 is identical to the content ID 110 and accounting manner information 122 includes account information according to the usage of the content. In addition, an encoding key 124 means a key encoding the original content when the DRM is applied to the content. The client can use the encoding key 124 to decode the original content. The reason is that the decoding key is identical to the encoding key in a symmetric key encoding algorithm. Referring to FIG. 10, in the client database DBcn, a content ID 130 is identical to the content ID 110 and a relay user information 132 is information of a user relaying the content to the client. The user relaying the content can share the profit based on the relay user information 132 when the client uses the content. Information is recorded in settlement information 134 and in a decoding key 136 when a charge has been paid for the corresponding content, so that the content can be used in off-line environment. The client, who has paid the charge for the content, can use the content in an off-line state based on above information.

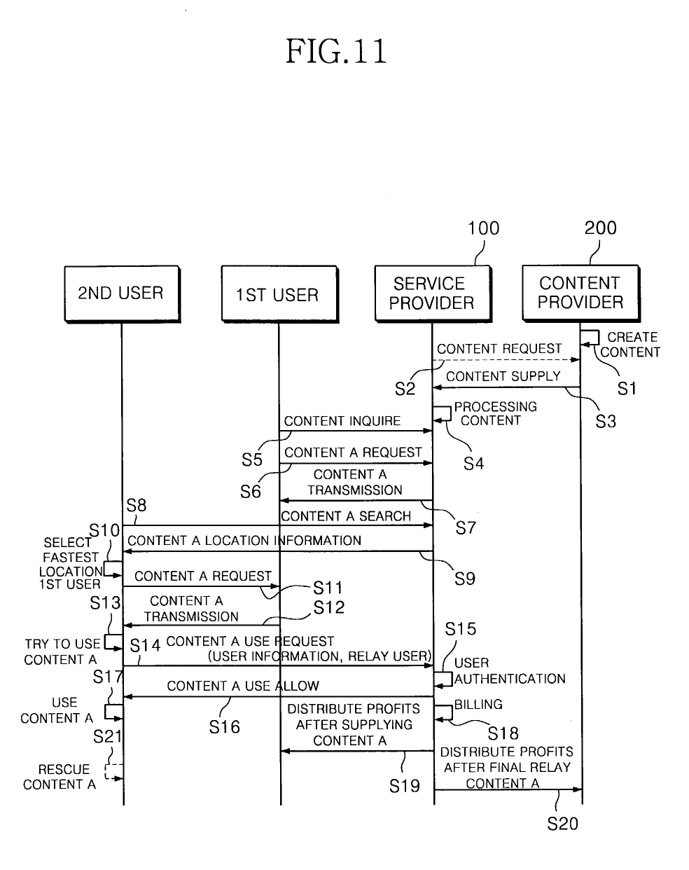

FIG. 11 is a view showing a download type distributing method according to one embodiment of the present invention.

Firstly, the content provider 200 creates the content (S1). The content provider 200 includes not only record and movie manufacturing companies, but also a private person.

Then, the service provider 100 requests the content to the content provider 200 in order to distribute predetermined content (S2).

Accordingly, the content are supplied to the service provider 100 from the content provider 200 (S3).

After that, an authentication procedure is carried out in order to protect the copyright and to define the rating of the content. Then, as shown in FIG. 6, the content are converted into digital content including the DRM (S4).

Next, the first user relaying the content accesses to a site provided by the service provider 100 and makes inquire about required content (S5).

Then, the first user searches content information and requests a content A, which may be frequently used by the users (S6). At this time, the first user directly downloads the content A from the service provider or other relay users.

The service provider 100 transmits the requested content A to the first user (S7). After the transmission has been completed, the first user can share the profit if other user uses the content A stored in a computer of the first user.

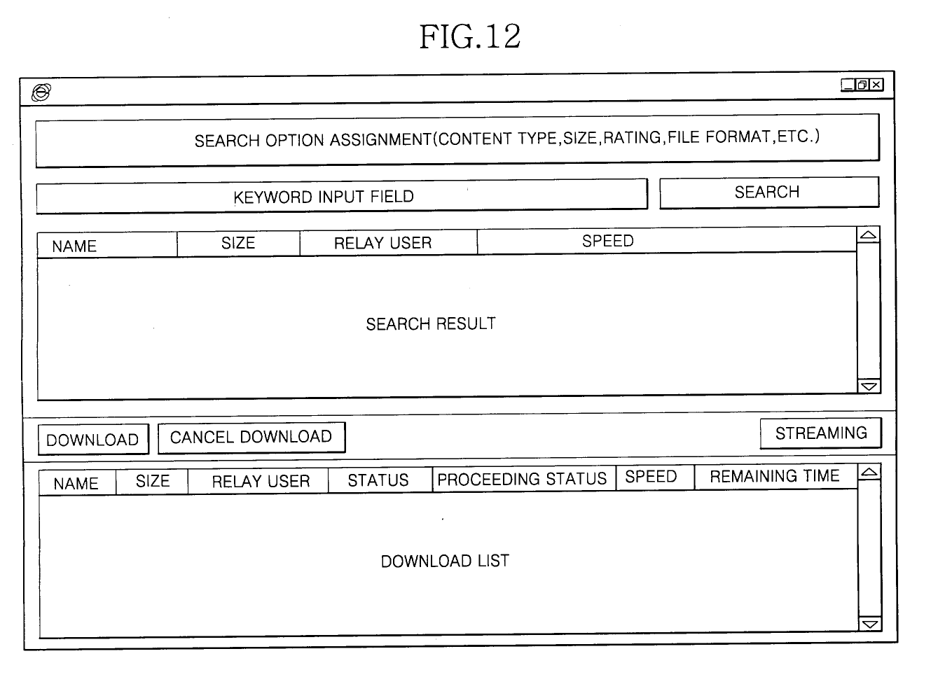

The second user carries out a search by inputting key words through a search interface in order to use the content A (S8). FIG. 12 is an example showing a graphic screen of a user interface used for a content search.

When content are searched in the graphic screen shown in FIG. 12, a search result list is displayed. The search result list displays a name, a size, a relay user, and a transmission speed of the content. In the graphic screen shown in FIG. 12, a selection key capable of selecting one of a downloading format and a streaming format is provided and the content downloaded from the search result is displayed as a download list.

The download list displays a name, a size, a relay user, a status, a proceeding state, a transmission speed, and remaining time of the content.

Upon receiving the search request for the content A from the second user, the service provider 100 searches the DBS1 of the server in order to provide the second user with information of the users holding the content A as shown in FIG. 12 (S9).

After receiving information of users holding the content A from the service provider 100, a client program of the second user checks the network speed between the second user and other users and displays the results in a search result window as shown in FIG. 12. Based on the results displayed in the search result window, the second user selects a relay user having the fastest transmission speed of the content A or a specific relay user acquainted with the second user (S10).

Then, the second user clicks the content A and pushes a download button so as to receive the download service from the relay user selected in FIG. 12 (S11).

Accordingly, the first user, who receives the request for the content A from the second user, transmits the content A to the second user (S12). The second user records the content ID and information of the relay user in a content list DB of the second user when the content A are transmitted to the second user from the first user.

If the distributing model is designed such that all relay users evenly share the profit, a final user records and manages information of all relay users participated in a digital content distribution work.

The second user checks settlement information provided in the content list DB, when the second user tries to use the content A, after completing the download of the content A (S13). If the settlement is not settled, a settlement procedure is carried out.

That is, the second user provides the service provider 100 with settlement information for using the content A (S14). At this time, the service provider 100 receives the content ID, user information, and relay user information from the second user.

Then, an authentication procedure is carried out by the service provider 100 to determine whether or not the second user is a normal user having a right to use the content A (S15).

If the authentication is successfully completed, the service provider records that the second user wants to use the content A provided from the first user and provides information for using the content A to the second user (S16).

Then, the second user receives settlement information and the decoding key for the content A from the service provider 100, thereby using the content A (S17).

Next, the service provider 100 carries out a billing work based on information recorded in step S16.

After the billing work has been completed, the profit is evenly distributed to all relay users participated in the distribution of the content A (S19).

In addition, the profit is also distributed to the content provider 200 providing the content A (S20).

If the second user already has paid the charge for reusing the content A in the future, information regarding the payment remains in settlement information of the content list DB, so the authentication and settlement procedures are not required for the second user when reusing the content (S21).

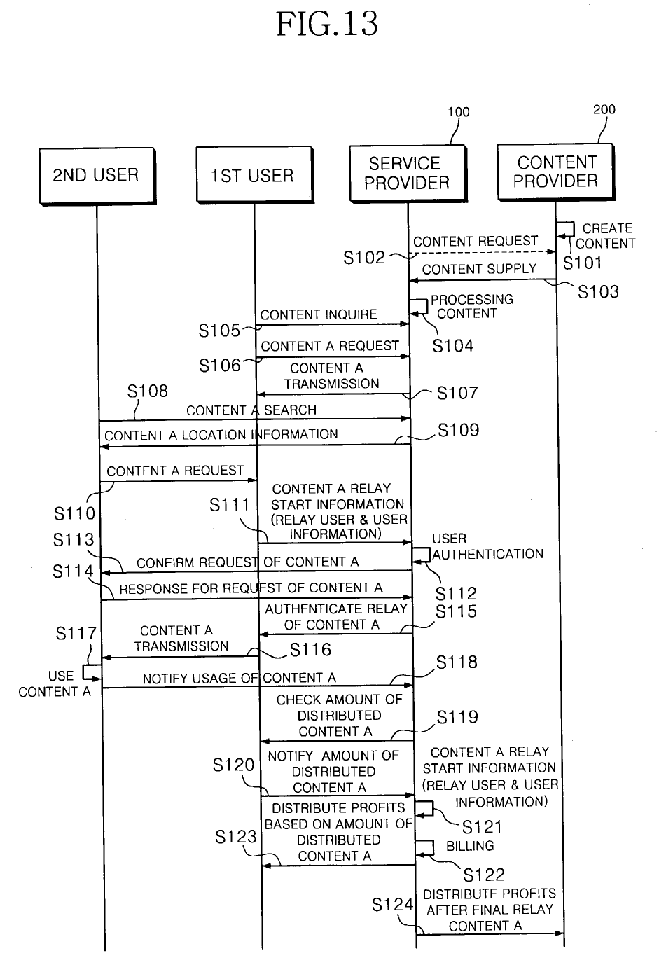

FIG. 13 is a view showing a streaming type distributing method according to one embodiment of the present invention.

According to the present invention, it is possible to provide a streaming service with respect to the digital content including video, music, and education. Firstly, the content provider 200 creates the content (S101). The content provider 200 includes not only companies, such as record and movie manufacturing companies, but also a private person.

Then, the service provider 100 requests the content to the content provider 200 in order to distribute predetermined content (S102).

Accordingly, the content are supplied to the service provider 100 from the content provider 200 (S103).

After that, an authentication procedure is carried out in order to protect the copyright and to define the rating of the content. Then, as shown in FIG. 6, the content are converted into digital content including the DRM (S104).

Next, the first user relaying the content accesses to a site provided by the service provider 100 and makes inquire about required content (S105).

Then, the first user searches content information and requests content A, which may be frequently used by the users (S106).

The service provider 100 transmits the content A to the first user (S107). After the transmission has been completed, the first user can share the profit if other user uses the content A stored in a computer of the first user.

The second user carries out a search by inputting key words through a search interface in order to use the content A (S108). FIG. 12 is an example showing a graphic screen of a user interface used for a content search.

When content are searched, a search result list is displayed in the graphic screen shown in FIG. 12. The search result list displays a name, a size, a relay user, and a transmission speed of the content. In the graphic screen shown in FIG. 12, a selection key capable of selecting one of a downloading format and a streaming format is provided and the content downloaded from the search result is displayed as a download list.

The download list displays a name, a size, a relay user, a status, a proceeding state, a transmission speed, and remaining time of the content.

Upon receiving the search request for the content A from the second user, the service provider 100 searches the DBS1 of the server in order to provide the second user with information of the users holding the content A as shown in FIG. 12 (S109).

Similar to the download service, the second user requests the content A to a relay user having the fastest transmission speed of the content A (S110). As shown in FIG. 12, the second user clicks a streaming service button in the search interface if the second user wants to use the streaming service.

Then, the first user, who receives the request for the content A from the second user, notifies the service provider 100 that the first user will provide the streaming service of the content A to the second user, for the purpose of an account (S111).

Then, an authentication procedure is carried out by the service provider 100 to determine whether or not the second user requesting the content A is a normal user having a right to use the content A (S112).

In addition, it is checked whether or not the second user really requests the content A to the first user (S113) and a settlement manner is requested.

Then, the second user notifies the service provider 100 that the second user really wants to use the content A of the first user, with informing the service provider 100 of the settlement manner of the second user (S114).

Next, the service provider 100 permits the first user to provide the content A to the second user (S115). Accordingly, the second user can use the content A, which means that the account is successfully completed.

Thus, the streaming service is provided to the second user to allow the second user to use the content A (S116).

Accordingly, the second user can use the content A transmitted from the first user (S117).

Then, the second user informs the service provider 100 of the usage of content A (S118).

The service provider 100 inquires of the first user for an amount of the content A transmitted to second user in order to compare the amount of the content A with that informed from the second user (S119).

The first user informs the service provider 100 of the amount of content A transmitted to the second user (S120).

Then, the service provider 100 corrects a deviation between the usages of the content A provided from the second user and the amount of the content A provided from the first user (S121).

In addition, a billing work is carried out based on the corrected value (S122).

After performing the billing work, the profit is distributed to the first user relaying the content A and relay users participated in the distribution of the content A (S123).

In addition, the profit is also distributed to the content provider who creates the content A (S124).

As mentioned above, the present invention adopts the P2P, the DRM and the incentive technique in order to distribute the digital content by using the user resources. In addition, the present invention distributes the profit obtained by distributing the digital content to the relay users, thereby promoting the distribution of the digital content. According to the present invention, the service traffic is distributed, so that the convenience of using the digital content is improved and the investment cost is saved even if the amount of digital content to be distributed is increased.

Furthermore, the present invention prevents the digital content from being illegally used by ensuring the legal content distribution. In addition, it is possible to record and manage the usage of the digital content, and the account according to the use of the digital content can be imposed and settled through an on-line system.

While the present invention has been described in detail with reference to the preferred embodiment thereof, it should be understood to those skilled in the art that various changes, substitutions and alterations can be made hereto without departing from the scope of the invention as defined by the appended claims.

What is claimed is:

1. A method for distributing digital content from a service provider to a user through an on-line system of a computer communication network, the method comprising:
preparing the digital content by the service provider;
downloading the digital content by a first user;
downloading the digital content from the first user by a second user;
requesting a permission to the service provider by the second user for permitting the second user to use the digital content;
authenticating a use of the digital content by the service provider;
using the digital content by the second user when an authentication for the use of the digital content is achieved; and
distributing a profit to the first user, who relays the digital content, by the service provider.

2. The method as claimed in claim 1, wherein the second user searches the digital content by accessing to the service provider, selects one of first users who already download the digital content searched by the second user, and downloads the digital content from the selected first user.

3. The method as claimed in claim 2, wherein the second user selects the first user having a fastest transmission speed of the digital content with respect to the second user.

4. The method as claimed in claim 1, wherein the digital content is provided by a content provider.

5. The method as claimed in claim 4, wherein the profit is distributed to the content provider when the digital content are used.

6. The method as claimed in claim 4, wherein the digital content provided by the content provider are processed as digital content including a digital rights management (DRM) capable of protecting a copyright and defining a rating of the digital content.

7. The method as claimed in claim 1, wherein the service provider receives information of a final relay user when the second user requests the use of the digital content, and provides a decoding key for permitting the second user to use the digital content.

8. The method as claimed in claim 1, wherein, when the second user requests the use of the digital content, the service provider checks whether or not the digital content are reused by the second user, and permits the second user to use the digital content without the authentication if the second user reuses the digital content.

9. The method as claimed in claim 1, wherein the first user downloads the digital content not only from the service provider, but also from other first users who already download the digital content from the service provider.

10. The method as claimed in claim 9, wherein the profit is distributed to all first users participated in relaying the digital content to the second user.

11. An apparatus for distributing digital content from a service provider to a user through an on-line system of a computer communication network, the apparatus comprising:
a storage means including a digital content search database and a digital content rights management database; and
a processor for operating a content distributing program through the on-line system, preparing the digital content, downloading the digital content upon receiving a request from a first user, authenticating a use of the digital content by checking the use of the digital content upon receiving a request from a second user, and distributing a profit to the first user participated in relaying the digital content to the second user.

12. The apparatus as claimed in claim 11, wherein the digital content database includes a content ID, content meta information, and a content holding user list.

13. The apparatus as claimed in claim 11, wherein the digital content rights management database includes a content ID, account manner information, and an encoding key.

14. A method for distributing digital content from a service provider to a user through an on-line system of a computer communication network, the method comprising:
preparing the digital content by the service provider;
downloading the digital content through a first user;
requesting the digital content to the first user by the second user;
informing the service provider of a distribution of the digital content to the second user by the first user;
authenticating a use of the digital content for the second user by the service provider;
permitting the first user to distribute the digital content to the second user by the service provider;
distributing the digital content to the second user by the first user;
informing the service provider of an amount of the digital content distributed to the second user from the first user by the second user;
checking the amount of the digital content distributed to the second user from the first user by the service provider; and
distributing a profit to the first user by the service provider according to the amount of the digital content distributed to the second user.

15. The method as claimed in claim 14, wherein the second user searches the digital content by accessing to the service provider, selects one of first users who already download the digital content searched by the second user, and downloads the digital content from the selected first user.

16. The method as claimed in claim 15, wherein the second user selects the first user having a fastest transmission speed of the digital content with respect to the second user.

17. The method as claimed in claim 14, wherein the digital content is provided by a content provider.

18. The method as claimed in claim 17, wherein the profit is distributed to the content provider when the digital content are used.

19. The method as claimed in claim 17, wherein the digital content provided by the content provider are processed as digital content including a digital rights management (DRM) capable of protecting a copyright and defining a rating of the digital content.

20. An apparatus for distributing digital content from a service provider to a user through an on-line system of a computer communication network, the apparatus comprising:
a storage means including a digital content search database and a digital content rights management database; and
a processor for operating a content distributing program through the on-line system, preparing the digital content, downloading the digital content upon receiving a request from a first user, receiving a report from the first user informing a distribution of the digital content requested by the second user, authenticating a use of the digital content, permitting the first user to distribute the digital content to the second user, receiving a report from the second user informing an amount of the digital content thereof, checking an amount of the digital content of the first user distributed to the second user, and distributing a profit to the first user according to the amount of the digital content distributed to the second user.

21. The apparatus as claimed in claim 20, wherein the digital content database includes a content ID, content meta information, and a content holding user list.

22. The apparatus as claimed in claim 20, wherein the digital content rights management database includes a content ID, account manner information, and an encoding key
